(19) United States
(12) Patent Application Publication
(10) Pub. No.: US 2003/0047905 A1
(43) Pub. Date: Mar. 13, 2003

(54) Rear wheel suspension for a bicycle

(76) Inventor: Jonathan Duval, Edmonton (CA)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 10/241,228

(22) Filed: Sep. 10, 2002

(30) Foreign Application Priority Data
Sep. 11, 2001 (CA) 2,357,167

(51) Int. Cl. B62K 1/00

(52) U.S. Cl. 280/284

(57) ABSTRACT

A rear wheel suspension for a bicycle having a main frame, a rear wheel mounting and a resilient linkage coupling the main frame and the rear wheel mounting. The resilient linkage includes a first pair of vertically spaced linkage points on the main frame including a first upper linkage point and a first lower linkage point. A second pair of vertically spaced linkage points are provided on the rear wheel mounting including a second upper linkage point and a second lower linkage point. A first linkage member is provided having a first end connected to the first upper linkage point and a second end connected to the second lower linkage point. A second linkage member is provided having a first end connected to the first lower linkage point and a second end connected to the second upper linkage point. This resilient linkage reduces lost pedalling force.

### FIELD OF THE INVENTION

The present invention relates to a rear wheel suspension for a bicycle.

### BACKGROUND OF THE INVENTION

Rear wheel suspensions which shield bicycle riders from rear wheel impact, necessarily absorb a portion of the pedalling force which would otherwise provide forward movement. Among the more efficient rear wheel suspensions are suspensions which include resilient linkages coupling a main bicycle frame and a rear wheel mounting. Various embodiments of suspensions having such resilient linkages are disclosed in U.S. Pat. Nos. 4,332,246 (Lawwill 1988); 5,121,937 (Lawwill 1992); 5,332,246 (Buell) and 5,957,473 (Lawwill 1999).

### SUMMARY OF THE INVENTION

The present invention relates to a rear wheel suspension for a bicycle that utilizes an alternative form of resilient linkage.

According to the present invention there is provided a rear wheel suspension for a bicycle having a main frame, a rear wheel mounting and a resilient linkage coupling the main frame and the rear wheel mounting. The resilient linkage includes a first pair of vertically spaced linkage points on the main frame including a first upper linkage point and a first lower linkage point. A second pair of vertically spaced linkage points are provided on the rear wheel mounting including a second upper linkage point and a second lower linkage point. A first linkage member is providing having a first end and a second end. The first end is connected to the first upper linkage point. The second end is connected to the second lower linkage point. A second linkage member is providing having a first end and a second end. The first end is connected to the first lower linkage point. The second end is connected to the second upper linkage point.

With the rear wheel suspension, as described above, when a bicycle rider pedals a torsional force is exerted by the bicycle chain upon the rear wheel mounting. This torsional force is transmitted from the second upper linkage point via the second linkage member to the first lower linkage point on the frame. A resisting force is transmitted from the second lower linkage point via the first linkage member to the first upper linkage point on the frame. These offsetting forces serve to reduce the amount of movement of the rear wheel mounting and, hence, the amount of pedalling force that is lost. The desired combination is produced of greater pedalling efficiency and a smoother ride.

There are two alternative ways in which the resilient linkage can be configured. With a first embodiment each of the first pair of vertically spaced linkage points and the second pair of vertically spaced linkage points are rigid, while the first linkage member and the second linkage member are resilient. With this first embodiment, a resilient flexing of the first linkage member and the second linkage member provides resiliency to the resilient linkage. With a second embodiment the first linkage member and the second linkage member are rigid, while the first pair of vertically spaced linkage points and the second pair of vertically spaced linkage points define pivot axes. With this second embodiment, a pivoting of the first linkage member and the second linkage member provides resiliency to the resilient linkage. A shock absorbing member, such as a hydraulic or pneumatic cylinder, is attached to one of the first linkage member and the second linkage member to control and dampen pivotal movement about the pivot axes.

If the first linkage member and the second linkage member are both straight a “crossed” linkage is created that leaves very little space for the drive chain of the bicycle. It is, therefore, preferred that one or both of the first linkage member or the second linkage member has a bend. This creates room to accommodate a drive chain extending from the frame to the rear wheel mounting. By “bend” there is not meant a physical bending process. The term is intended to encompass any deviation of one of the linkage members that serves to provide room for passage of the drive chain.

As described above, the resilient linkage responds best to torsional forces. Even more beneficial results may, therefore, be obtained when the rear wheel mounting is triangular with three vertex; with one of the second upper linkage, the second lower linkage, and a rear wheel axle support positioned at each vertex. When a rear wheel is mounted on the rear wheel axle support, virtually every force exerted by the rear wheel upon the triangular rear wheel mounting will have a substantial torsional component.

### BRIEF DESCRIPTION OF THE DRAWINGS

These and other features of the invention will become more apparent from the following description in which reference is made to the appended drawings, the drawings are for the purpose of illustration only and are not intended to in any way limit the scope of the invention to the particular embodiment or embodiments shown, wherein:

FIG. 1 is a side elevation view of a first embodiment of rear wheel suspension for a bicycle constructed in accordance with the teachings of the present invention.

FIG. 2 is top plan view of a first embodiment of rear wheel suspension illustrated in FIG. 1.

FIG. 3 is a side elevation view of a second embodiment of rear wheel suspension for a bicycle constructed in accordance with the teachings of the present invention.

FIG. 4 is a side elevation view of a third embodiment of rear wheel suspension for a bicycle constructed in accordance with the teachings of the present invention, with resilient linkage in a first or rest position.

FIG. 5 is a side elevation view of the third embodiment of rear wheel suspension for a bicycle illustrated in FIG. 3, with resilient linkage in a second or compressed position.

### DETAILED DESCRIPTION OF THE PREFERRED EMBODIMENT

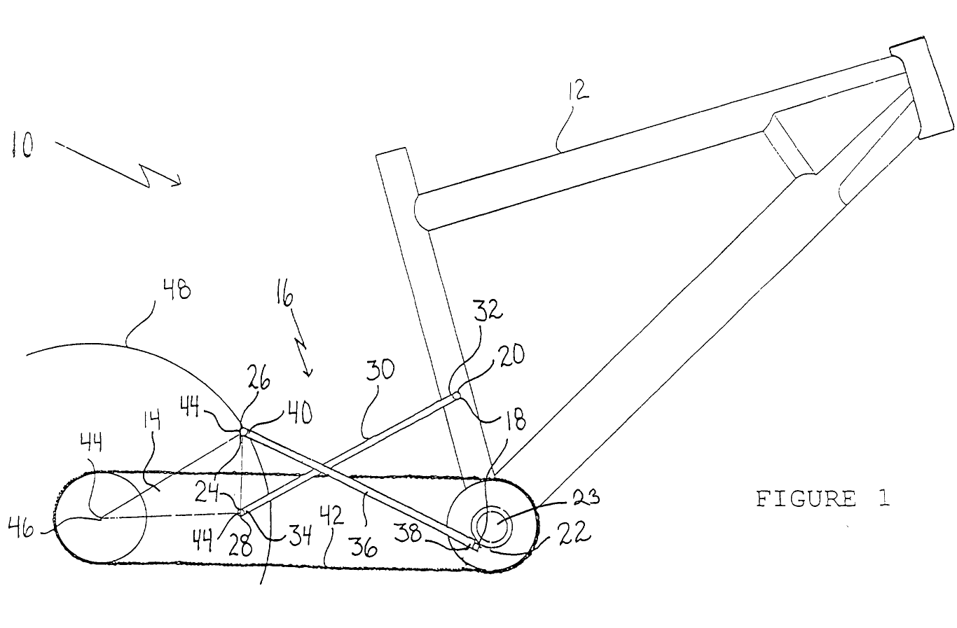

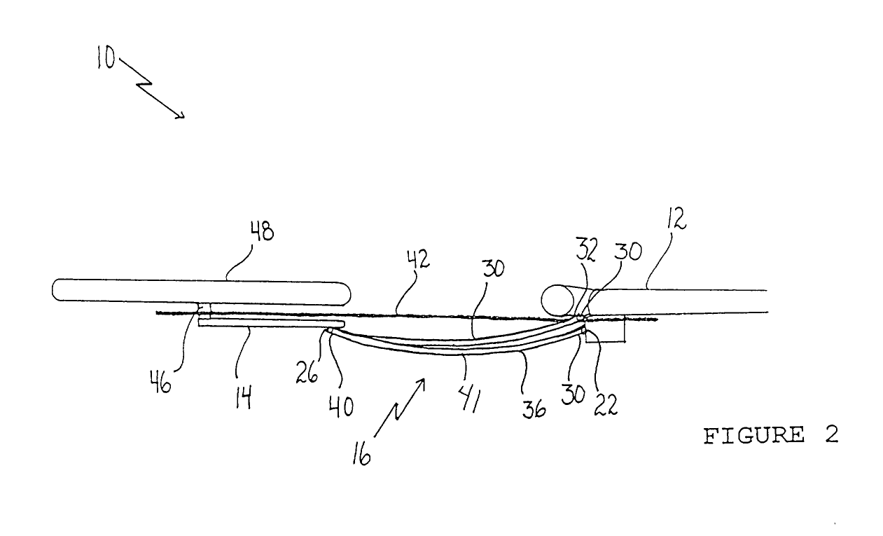

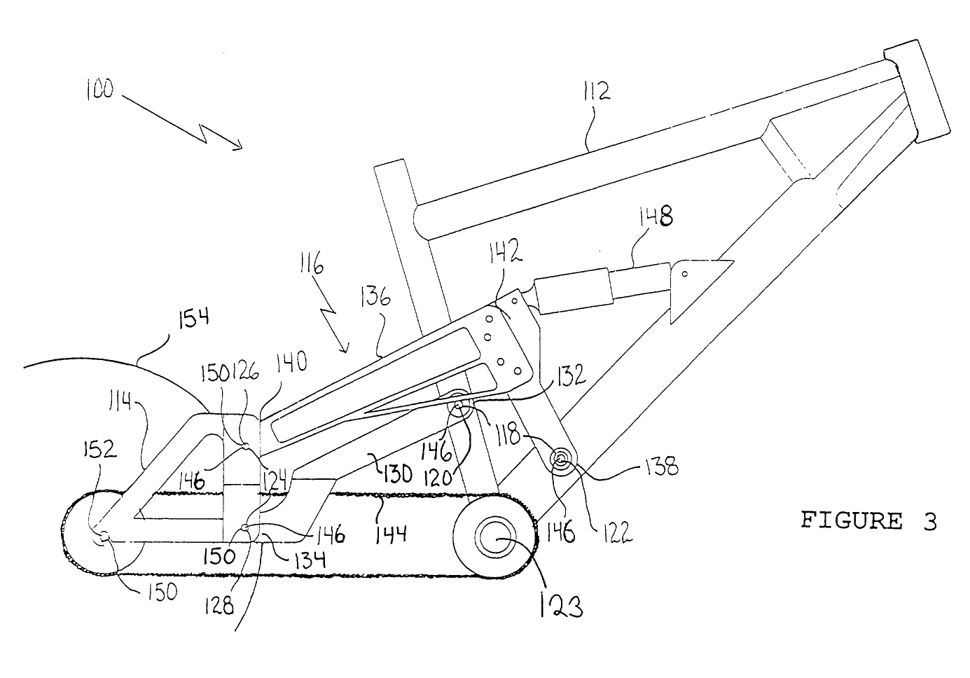

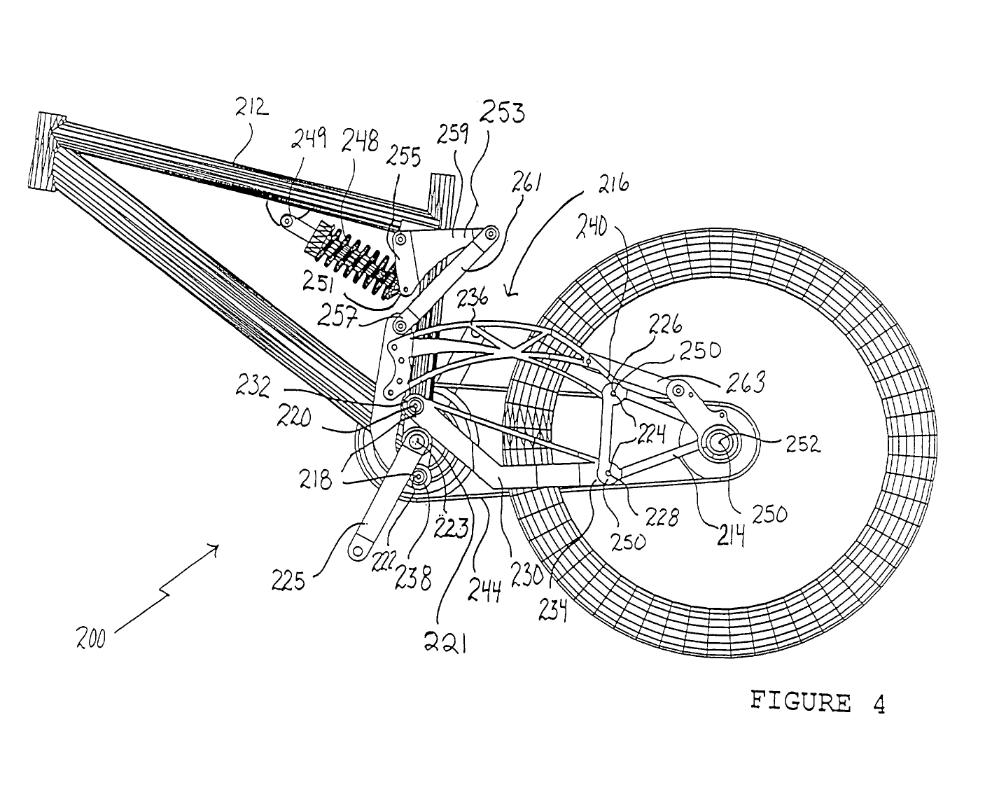

The preferred embodiment, a rear wheel suspension for a bicycle will now be described. A first embodiment of rear wheel suspension, generally identified by reference numeral 10, will be described with reference to FIGS. 1 and 2. A second embodiment of rear wheel suspension, generally identified by reference numeral 100, will be described with reference to FIG. 3. A third embodiment of rear wheel suspension, generally identified by reference numeral 200, will be described with reference to FIGS. 3 and 4.

Structure and Relationship of Parts on First Embodiment:

Referring to FIG. 1, rear wheel suspension 10 has a main frame 12, a rear wheel mounting 14 and a resilient linkage 16 coupling main frame 12 and rear wheel mounting 14. Resilient linkage 16 includes a first pair of vertically spaced rigid linkage points 18 on main frame 12 including a first upper linkage point 20 and a first lower linkage point 22. A second pair of vertically spaced rigid linkage points 24 are provided on rear wheel mounting 14 which include a second upper linkage point 26 and a second lower linkage point 28. A flexing resilient first linkage member 30 is provided that has a first end 32 and a second end 34. First end 32 is connected to first upper linkage point 20 and second end 34 is connected to second lower linkage point 28. A flexing resilient second linkage member 36 is provided that has a first end 38 and a second end 40. First end 38 is connected to first lower linkage point 22 and second end 40 is connected to second upper linkage point 26. Referring to FIG. 2, first linkage member 30 and second linkage member 36 have outwardly curved bends 41, whereby room is provided to accommodate a drive chain 42 extending from main frame 12 to rear wheel mounting 14.

Referring to FIG. 1, rear wheel mounting 14 is triangular with three vertex 44 including second upper linkage point 26, second lower linkage point 28, and a rear wheel axle support 46 being positioned at each vertex 44. A rear wheel 50 is mounted on rear wheel axle support 46.

Operation of First Embodiment:

The use and operation of rear wheel suspension 10 will now be described with reference to FIG. 1. Referring to FIG. 1, with rear wheel suspension 10, as described above, when a bicycle rider pedals a torsional force is exerted by bicycle chain 42 upon rear wheel mounting 14. This torsional force is transmitted from second upper linkage point 26 via second linkage member 36 to first lower linkage point 22 on frame 12. A resisting force is transmitted from second lower linkage point 28 via first linkage member 30 to first upper linkage point 20 on frame 12. These offsetting forces serve to reduce the amount of movement of rear wheel mounting 14 and, hence, the amount of pedalling force that is lost. The desired combination is produced of greater pedalling efficiency and a smoother ride. Each of first pair of vertically spaced linkage points 18 and the second pair of vertically spaced linkage points 24 are rigid, while first linkage member 30 and second linkage member 36 are resilient. A resilient flexing of first linkage member 30 and second linkage member 36 provides resiliency to resilient linkage 16.

Referring to FIG. 2, first linkage member and second linkage member 36 have outwardly curved bends to create room to accommodate a drive chain 42 as it extends from frame 12 to rear wheel mounting 14. If first linkage member 30 and second linkage member 36 were both straight then a “crossed” linkage would be created that would leave very little space for drive chain 42.

Referring to FIG. 1, resilient linkage 16 responds best to torsional forces. As rear wheel mounting 14 is triangular with three vertex 44, when a rear wheel 48 is mounted on rear wheel axle support 46, virtually every force exerted by rear wheel 48 upon rear wheel mounting 14 will have a substantial torsional component.

Structure and Relationship of Parts on Second Embodiment:

Referring to FIG. 3, rear wheel suspension 100 has a main frame 112, a rear wheel mounting 114 and a resilient linkage 116 coupling main frame 112 and rear wheel mounting 114. Resilient linkage 116 includes a first pair of vertically spaced pivotal linkage points 118 on main frame 112. First pair of vertically spaced pivotal linkage points 118 include a first upper linkage point 120 and a first lower linkage point 122. A second pair of vertically spaced pivotal linkage points 124 on rear wheel mounting 114 include a second upper linkage point 126 and a second lower linkage point 128.

A rigid first linkage member 130 is provided that has a first end 132 and a second end 134. First end 132 is connected to first upper linkage point 120 and second end 134 is connected to second lower linkage point 128. A rigid second linkage member 136 is provided that has a first end 138 and a second end 140. First end 138 is connected to first lower linkage point 122 and second end 140 is connected to second upper linkage point 126. Second linkage member 136 has a bend 142, whereby room is provided to accommodate a drive chain 144 extending from frame 112 to rear wheel mounting 114. First pair of vertically spaced pivotal linkage points 118 and second pair of vertically spaced pivotal linkage points 124 define pivot axes 146, such that a pivoting of first linkage member 130 and second linkage member 136 provides resiliency to the resilient linkage 116. A pneumatic cylinder 148 extends from frame 12 and attaches to second linkage member 136. Rear wheel mounting 114 is triangular with three vertex 150, which include second upper linkage point 126, second lower linkage point 128, and a rear wheel axle support 152 being positioned at each vertex 150. A rear wheel 154 is mounted on rear wheel axle support 152.

Operation of Second Embodiment:

The use and operation of second embodiment of rear wheel suspension 100 will now be described with reference to FIG. 3. Referring to FIG. 3, like first embodiment 10, with second embodiment of rear wheel suspension 100 as described above, when a bicycle rider pedals a torsional force is exerted by bicycle chain 144 upon rear wheel mounting 114. Torsional force is transmitted from second upper linkage point 126 via second linkage member 136 to first lower linkage point 122 on frame 112. A resisting force is transmitted from second lower linkage point 128 via first linkage member 130 to first upper linkage point 120 on frame 112. These offsetting forces serve to reduce the amount of movement of rear wheel mounting 114 and, hence, the amount of pedalling force that is lost. The result is a combination of greater pedalling efficiency and a smoother ride. Second embodiment 100 differs from first embodiment 10 in that with second embodiment of rear wheel suspension 100, first linkage member 130 and second linkage member 136 are rigid, while first pair of vertically spaced linkage points 118 and second pair of vertically spaced linkage points 124 define pivot axes 144. With second embodiment of rear wheel suspension 100, pivoting of first linkage member 130 and second linkage member 136 provides resiliency to resilient linkage. Pneumatic cylinder 146 is attached to second linkage member 136 and operates as a shock absorber to control and dampen pivotal movement about pivot axes 146. While pneumatic cylinder 148 is illustrated as being attached to second member 136, it could also be attached to first member 130 and still operate. It will also be appreciated that other types of shock absorbing members such as hydraulic cylinders can be used instead of pneumatic cylinder 148.

As with first embodiment 10, with second embodiment 100, if first linkage member 130 and second linkage member 136 are both straight then a “crossed” linkage is created that leaves very little space for drive chain 144. As a result, in second embodiment 100, second linkage member 136 has bend 142 which creates room to accommodate drive chain 144 as it extends from frame 112 to rear wheel mounting 114. While in the illustrated embodiment 100, second linkage member 136 has bend 142, it will be appreciated that either or both of first linkage member 130 and second linkage member 136 can have bend 142. It will also be appreciated that the term “bend” is intended to encompass any deviation in either first linkage member 130 and second linkage member 136 that serves to provide room for passage of drive chain 144.

Resilient linkage 116 responds best to torsional forces. As rear wheel mounting 114 is triangular with three vertex 148, when rear wheel 154 is mounted on rear wheel axle support 152, virtually every force exerted by rear wheel 154 upon rear wheel mounting 114 will have a substantial torsional component.

Cautionary Warnings:

If there is excessive torsional force exerted, it will fatigue the drive chain and lead to drive chain failure. However, if there is minimal torsional force exerted, it reduces the mechanical advantage provided by the described embodiments. Rear wheel suspension systems constructed in accordance with the teachings of the present invention should be built to generate sufficient torsional forces to provide the desired mechanical advantage without causing undue stress on the drive chain. One factor to be considered is the angle of incline at rest of the first linkage member and the second linkage member. The angle of incline at rest is, preferably, relatively flat. The greater the angle of incline, the greater the strain that is placed upon the drive chain. Another factor to be considered is the relative spacing of the linkage points. The vertical distance between the linkage points should always be less than the horizontal spacing between the pairs of linkage points. Preferably the resistance is progressive; the more the wheel mounting twists, the more the resistance increases in response.

Structure and Relationship of Parts on Third Embodiment:

When evaluating the linkages to seek an optimum configuration, it is recommended that the length of the chain should be measured through the range of movement of the linkage. It is preferred that the length of the chain remain substantially constant. Any slack or stretch which is created in the chain length through the range of movement can be taken up by the derailleur. Care should be taken to limit this differential to approximately 1 inch, and preferably less. If the chain is continually being stretched, it will fatigue and ultimately fail. If the chain is continually stretched to a greater degree than can be accommodated by the derailleur, it may fail rapidly and abruptly.

Referring to FIG. 4, rear wheel suspension 200 is an embodiment which was developed to reduce chain stretch after some experience in testing various alternative configurations. Rear wheel suspension 200 is for a bicycle having a main frame 212, a rear wheel mounting 214 and a resilient linkage 216 coupling main frame 212 and rear wheel mounting 214. Resilient linkage 216 includes a first pair of vertically spaced pivotal linkage points 218 on main frame 212. First pair of vertically spaced linkage points 218 include a first upper linkage point 220 and a first lower linkage point 222. Experimentation indicated that there was the least stress on the chain when the first upper linkage point 220 and first lower linkage point 222 were positioned adjacent to, equidistant from and on opposed sides of a bottom bracket 221 which accommodates a crankshaft 223 for pedal cranks 225. This relationship will be noted on FIG. 4.

There is also a second pair of vertically spaced pivotal linkage points 224. These linkage points are positioned on rear wheel mounting 214. Second pair of vertically spaced pivotal linkage points 224 include a second upper linkage point 226 and a second lower linkage point 228. Experimentation determined that there was less stress on the chain when rear wheel mounting 214 was triangular with three vertex 250. One of second upper linkage point 226, the second lower linkage point 228, and a rear wheel axle support 252 is positioned at each vertex 250.

Experimentation determined that there was less stress on the chain when resilient linkage 216 was symmetrical with the distance from first upper linkage point 220 to second lower linkage point 228 being equal to the distance from first lower linkage point 222 to second upper linkage point 226.

A rigid first linkage member 230 is provided a first end 232 and a second end 234. First end 232 is connected to first upper linkage point 220. Second end 234 is connected to second lower linkage point 228. First linkage member 230 has both a dogleg bend and a slight outward bow to ensure that adequate room is provided to accommodate a drive chain 244 which extends from frame 212 to rear wheel mounting 214.

A rigid second linkage member 236 is provided having a first end 238 and a second end 240. First end 238 is connected to first lower linkage point 222 and second end 240 is connected to second upper linkage point 226. Second linkage member 236 also has a dogleg bend and a slight outward bow to ensure that adequate room is provided to accommodate drive chain 244.

It will be understood that first pair of vertically spaced pivotal linkage points 218 and second pair of vertically spaced pivotal linkage points 224 define pivot axes, such that a pivoting of first linkage member 230 and second linkage member 236 provides resiliency to resilient linkage 216.

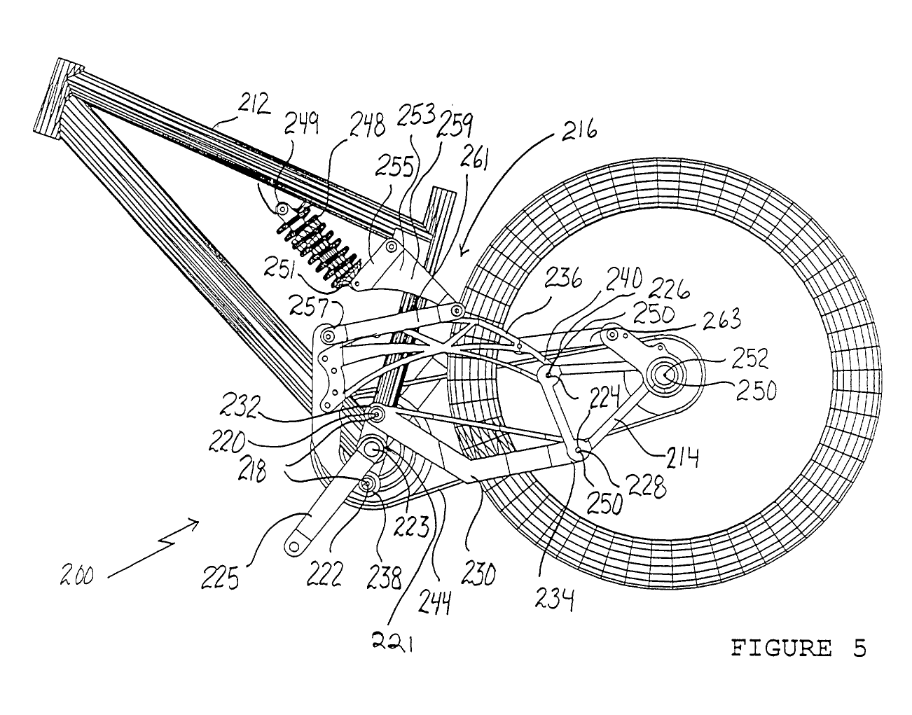

A shock absorbing member 248 is provided which has a first end 249 and a second end 251. First end 249 is attached to frame 212. Second end 251 is indirectly secured through a shock transfer linkage 253 to second linkage member 236. Shock transfer linkage 253 has a first end 255 which is pivotally attached to shock absorbing member 248 and a second end 257 which is pivotally attached to second linkage member 236. With the other embodiments shock absorbing members were directly secured to the bicycle. However, when first pair of vertically spaced pivotal linkage points 224 were lowered to be positioned adjacent to and on opposed sides of bottom bracket 221, it was discovered that a direct attachment to the frame provided undesirable force vectors. Shock absorbing member 248 works most efficiently when the force acting upon shock absorbing member 248 is an axial force. Shock transfer linkage 253 is intended to create an axial force vector upon shock absorbing member 248. When constructing shock transfer linkage 253, calculations must be made as to compression ratios. A strong compression ratio is need in order to avoid the suspension “bottoming out” and transferring force directly to frame 212. Referring to FIG. 5, shock transfer linkage 253 has two pivotally connected arms: arm 259 and arm 261. It is to be noted that when resilient linkage 216 is at its maximum point of travel there is a 90 degree angle formed between arm 259 at first end 255 of shock transfer linkage 253 and shock absorbing member 248. Similarly, there is a 90 degree angle formed between arm 261 at second end 257 of shock transfer linkage 253 and second linkage member 236. It can be seen how shock absorbing member 248 serves to control and dampen pivotal movement of resilient linkage 216.

In order to better isolate resilient linkage 216 from braking forces, rear wheel suspension 200 has an added feature of a floating disk brake 263 secured between rear wheel axle support 252 and second linkage member 236.

Operation of Third Embodiment:

The use and operation of rear wheel suspension 200 will now be described with reference to FIGS. 4 and 5. Rear wheel suspension operates in substantially the same fashion as the other embodiments and, therefore, the overall description will not be repeated. It is to be noted, however, that through the range of motion illustrated between FIG. 4 and FIG. 5, there is negligible stretch upon drive chain 244. This is achieved through the positioning of first upper linkage point 220 and first lower linkage point 222 adjacent to, equidistant from and on opposed sides of bottom bracket 221. This is also achieved by the symmetry of the linkage with the distance from first upper linkage point 220 to second lower linkage point 228 being equal to the distance from first lower linkage point 222 to second upper linkage point 226.

This embodiment also has some features which contribute to improved performance, but are not related to chains stretch. With this embodiment both first linkage member 230 and second linkage member 236 have dogleg bends and slight outward bows to provide additional clearance for chain 244. With this embodiment shock transfer linkage 253 is provided in order to have an axial force vector acting upon shock absorbing member 248, with shock transfer linkage 253 being configured to provide advantageous compression ratios. With this embodiment floating disk brake 263 has been added to isolate braking forces.

Cautionary Notes

Bicycles are used for different purposes. The foregoing description provided the basic principles of operation. There will now be described some variables which may affect performance in specific applications. When downhill racing it is best to keep constant the distance between crankshaft 223 and rear wheel axle support 252. When the distance is constant, suspension activity is isolated from chain tension. This keeps the suspension far more active and keeps the suspension free from pedal feedback. In contrast, a little bit of chain tension is good on a trail bike. The trail bike will have less suspension travel and restricted suspension activity. In this case, a controlled lengthening of the distance between crankshaft 223 and rear wheel axle support 252 assists the rider to gain speed on flat terrain and during climbs.

In order to have a constant distance between crankshaft 223 and rear wheel axle support 252 the following conditions must exist:

1. first upper linkage point 220 and first lower linkage point 222 must be substantially aligned with and positioned equidistant from crankshaft 223, as illustrated in FIG. 4;

2. rear wheel axle mounting 252 must be positioned perpendicular centre between second upper linkage point 226 and second lower linkage point 228;

3. the distance from first upper linkage point 220 to second lower linkage point 228 must be substantially the same as the distance from second upper linkage point 226 to first lower linkage point 222.

This results in the distance between crankshaft 223 and rear wheel axle support 252 remaining sufficiently constant to get maximum activity from the suspension with no noticable pedal feedback.

In order to obtain some lengthening of the distance between the crankshaft and the rear wheel axle support, one or more of the following conditions must exist:

1. crankshaft 23 sitting closer to first lower linkage point 22 as illustrated in FIG. 1 or even crankshaft 123 sitting below first lower linkage point 122 as illustrated in FIG. 3;

2. the distance from first upper linkage point 120 to second lower linkage point 124 is not the same as the distance from second upper linkage point 126 to first lower linkage point 122, as illustrated in FIG. 3;

3. rear wheel axle support 152 is positioned below perpendicular centre between second upper linkage linkage point 126 and second lower linkage point 128, as illustrated in FIG. 3.

It is undesirable to have excessive lengthening of the distance between the crankshaft and the rear wheel axle support, as this will place undue strain upon the chain and lead to failure. However, by working with one or more of the above factors a selected lengthening can be achieved.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent to one skilled in the art that modifications may be made to the illustrated embodiment without departing from the spirit and scope of the invention as hereinafter defined in the claims.

The embodiments of the invention in which an exclusive property or privilege is claimed are defined as follows:

1. A rear wheel suspension for a bicycle having a main frame, a rear wheel mounting and a resilient linkage coupling the main frame and the rear wheel mounting, with the resilient linkage comprising:
a first pair of vertically spaced linkage points on the main frame including a first upper linkage point and a first lower linkage point;
a second pair of vertically spaced linkage points on the rear wheel mounting including a second upper linkage point and a second lower linkage point;
a first linkage member having a first end and a second end, the first end being connected to the first upper linkage point and the second end being connected to the second lower linkage point; and
a second linkage member having a first end and a second end, the first end being connected to the first lower linkage point and the second end being connected to the second upper linkage point.

2. The rear wheel suspension for a bicycle as defined in claim 1, wherein each of the first pair of vertically spaced linkage points and the second pair of vertically spaced linkage points are rigid, the first linkage member and the second linkage member being resilient, such that a flexing of the first linkage member and the second linkage member provides resiliency to the resilient linkage.

3. The rear wheel suspension for a bicycle as defined in claim 1, wherein the first linkage member and the second linkage member are rigid, the first pair of vertically spaced linkage points and the second pair of vertically spaced linkage points define pivot axes, and a shock absorbing member is attached to one of the first linkage member and the second linkage member, thereby controlling pivotal movement about the pivot axes, such that a pivoting of the first linkage member and the second linkage member provides resiliency to the resilient linkage.

4. The rear wheel suspension for a bicycle as defined in claim 1, wherein at least one of the first linkage member and the second linkage member has a bend, whereby room is provided to accommodate a drive chain extending from the frame to the rear wheel mounting.

5. The rear wheel suspension for a bicycle as defined in claim 4, wherein the second linkage member has a bend.

6. The rear wheel suspension for a bicycle as defined in claim 1, wherein the rear wheel mounting is triangular with three vertex, one of the second upper linkage point, the second lower linkage point, and a rear wheel axle support being positioned at each vertex.

7. A rear wheel suspension for a bicycle having a main frame, a rear wheel mounting and a resilient linkage coupling the main frame and the rear wheel mounting, with the resilient linkage comprising:
a first pair of vertically spaced rigid linkage points on the main frame including a first upper linkage point and a first lower linkage point;
a second pair of vertically spaced rigid linkage points on the rear wheel mounting including a second upper linkage point and a second lower linkage point;
a flexing resilient first linkage member having a first end and a second end, the first end being connected to the first upper linkage point and the second end being connected to the second lower linkage point;
a flexing resilient second linkage member having a first end and a second end, the first end being connected to the first lower linkage point and the second end being connected to the second upper linkage point;
both the first linkage member and the second linkage member having outwardly curved bends, such that room is provided to accommodate a drive chain extending from the frame to the rear wheel mounting and flexing of the first linkage member and the second linkage member is facilitated to provide resiliency to the resilient linkage.

8. The rear wheel suspension for a bicycle as defined in claim 7, wherein the rear wheel mounting is triangular with three vertex, one of the second upper linkage point, the second lower linkage point, and a rear wheel axle support being positioned at each vertex.

9. A rear wheel suspension for a bicycle having a main frame, a rear wheel mounting and a resilient linkage coupling the main frame and the rear wheel mounting, with the resilient linkage comprising:
a first pair of vertically spaced pivotal linkage points on the main frame including a first upper linkage point and a first lower linkage point;
a second pair of vertically spaced pivotal linkage points on the rear wheel mounting including a second upper linkage point and a second lower linkage point;
a rigid first linkage member having a first end and a second end, the first end being connected to the first upper linkage point and the second end being connected to the second lower linkage point;
a rigid second linkage member having a first end and a second end, the first end being connected to the first lower linkage point and the second end being connected to the second upper linkage point; the second linkage member having a bend, whereby room is provided to accommodate a drive chain extending from the frame to the rear wheel mounting;
the first pair of vertically spaced pivotal linkage points and the second pair of vertically spaced pivotal linkage points defining pivot axes, such that a pivoting of the first linkage member and the second linkage member provides resiliency to the resilient linkage; and
a shock absorbing member being attached to one of the first linkage member and the second linkage member, thereby controlling and dampening pivotal movement.

10. The rear wheel suspension for a bicycle as defined in claim 9, wherein the rear wheel mounting is triangular with three vertex, one of the second upper linkage point, the second lower linkage point, and a rear wheel axle support being positioned at each vertex.

11. A rear wheel suspension for a bicycle having a main frame, a rear wheel mounting and a resilient linkage coupling the main frame and the rear wheel mounting, with the resilient linkage comprising:
a first pair of vertically spaced pivotal linkage points on the main frame including a first upper linkage point and a first lower linkage point, the first upper linkage point and the first lower linkage point being positioned adjacent to, equidistant from and on opposed sides of a bottom bracket of the frame which accommodates a crankshaft for pedal cranks;
a second pair of vertically spaced pivotal linkage points on the rear wheel mounting including a second upper linkage point and a second lower linkage point, the rear wheel mounting being triangular with three vertex, one of the second upper linkage point, the second lower linkage point, and a rear wheel axle support being positioned at each vertex, the rear wheel mounting being oriented with the rear wheel axle support being positioned perpendicular centre between the second upper linkage point and second lower linkage point;
the distance from the first upper linkage point to the second lower linkage point being equal to the distance from the first lower linkage point to the second upper linkage point;
a rigid first linkage member having a first end and a second end, the first end being connected to the first upper linkage point and the second end being connected to the second lower linkage point, the first linkage member having a bend, whereby room is provided to accommodate a drive chain extending from the frame to the rear wheel mounting;
a rigid second linkage member having a first end and a second end, the first end being connected to the first lower linkage point and the second end being connected to the second upper linkage point; the second linkage member having a bend, whereby room is provided to accommodate a drive chain extending from the frame to the rear wheel mounting;
the first pair of vertically spaced pivotal linkage points and the second pair of vertically spaced pivotal linkage points defining pivot axes, such that a pivoting of the first linkage member and the second linkage member provides resiliency to the resilient linkage; and
a shock absorbing member having a first end and a second end, the first end being attached to the frame and the second end being indirectly secured through a shock transfer linkage to the second linkage member, thereby controlling and dampening pivotal movement.

12. The rear wheel suspension for a bicycle as defined in claim 11, wherein a floating disk brake is secured between the rear wheel mount and the second linkage member, thereby isolating braking force.
